(19) United States
(12) Patent Application Publication
(10) Pub. No.: US 2022/0051858 A1
(43) Pub. Date: Feb. 17, 2022

(54) LIGHT-GUIDE PLANAR STRUCTURE OF BACKLIGHT MODULE

(71) Applicant: SUZHOU WANXIANG TECHNOLOGY CO., LTD, Suzhou (CN)

(72) Inventors: Jun Huang, Suzhou (CN); Zhigang Zhang, Suzhou (CN); Guozhong Wu, Suzhou (CN)

(21) Appl. No.: 17/348,783

(22) Filed: Jun. 16, 2021

(30) Foreign Application Priority Data
Aug. 12, 2020 (CN) 202021662870.2

(51) Int. Cl. H01H 13/83; F21V 8/00

(52) U.S. Cl. CPC H01H 13/83; G02B 6/0055; H01H 2219/06; G02B 6/0085; H01H 2219/062; G02B 6/006

(57) ABSTRACT

The invention discloses a light-guide planar structure of a backlight module, comprising a backlight module including a luminescent lamp source, a reflecting plate, a light guide plate and a light shading plate with a plurality of preset key caps thereon, which are sequentially arranged, and a light guide structure which is arranged on the surface of the light guide plate, is planar and is a surface consisting of three or more circular or rectangular mesh points. The light-guide planar structure is simple in structure, has the effect of gathering and centralizing the light source, is stable in light guide effect, reduces light source waste and reduces module cost.

### TECHNICAL FIELD

The invention relates to the field of keyboard equipment, in particular to a light-guide planar structure of a backlight module.

### BACKGROUND

A computing machine, commonly known as a computer, is a modern electronic computing machine with a memory function used for high-speed computation, which can perform numerical computation and logical computation. It is a modern intelligent electronic equipment that can run according to programs and can automatically process massive data at a high speed. However, interface equipment, such as keyboard, mouse, etc., which is necessary for computer operation is a peripheral tool for the computer to execute various programs and various operations. As a result, the keyboard, as a necessary tool for most of users to operate the computer, is widely applied to a microcomputer and various terminal equipment. A computer user inputs various instructions and data to the computer through the keyboard to command work of the computer, and the running condition of the computer is output to a display, so that the operator can conveniently communicate with the computer via the keyboard and the display for modifying and editing the programs as wells as controlling and observing running of the computer.

Someone inputs a light guide plate and a light source technology into the keyboard and develops a backlight keyboard with a backlight module so as to conveniently use the computer when the light is not sufficient, so that the user can see the keyboard clearly in any case; however, the existing backlight keyboard light source is disperse and uneven in luminous emission, and many light sources are required for obtaining uniform luminescent effect, which wastes light source and increases manufacturing cost.

### SUMMARY

To solve the technical problem, the invention provides a light-guide planar structure of a backlight module, which is simple in structure, has the effect of gathering and centralizing the light source, is stable in light guide effect, reduces light source waste and reduces module cost.

To solve the technical problem, the invention provides a light-guide planar structure of a backlight module, comprising the backlight module including a luminescent lamp source, a reflecting plate, a light guide plate and a light shading plate with a plurality of preset key caps thereon, which are sequentially arranged, and a light guide structure which is arranged on the surface of the light guide plate, is planar and is a surface consisting of three or more circular or rectangular mesh points.

Further, the light guide structure has a planar shape formed by superposing and engaging a plurality of mesh points which are crossed with one another, where the distance of centers of circles of every two mesh points is not greater than the diameter of single mesh point.

Further, the light guide structure is arranged below the preset key caps.

Further, the reflecting plate is made of a single-layer insulating material.

Further, a plurality of luminescent components are arranged on the luminescent lamp source.

Further, the light guide structure is arranged on the surface of the light guide plate through a thermal transfer method.

Further, the light guide plate includes a reflecting surface close to the reflecting plate and a light-emitting surface close to the light shading plate.

The invention has the following beneficial effects: 1. the planar light guide structure consisting of three or more mesh points has the effect of gathering and centralizing the light source, and is stable in light guide effect.

2. the backlight module of the invention can project the light source by the luminant lamp source on the bottom for guiding the light source to the reflecting surface of the light guide plate and emit from the light outlet surface after being reflected, so that the light source can be uniformly projected to any position around the bottom of each preset key cap, i.e., obvious bright-light effect around the bottom of each preset key cap is kept, a light source loss phenomenon can be reduced, and excessive light sources can be saved, and thus, the number of the luminescent components of the luminescent lamp source 11 on the backlight module can be reduced.

### BRIEF DESCRIPTION OF THE FIGURES

FIG. 1 is a schematic diagram showing an integral structure of the invention.

FIG. 2 is a sectional view showing the structure of a preset key cap of the invention.

FIG. 3 is a schematic diagram showing a structure of a light guide area of the invention.

FIG. 4 is an enlarged view of a three-point constituent surface type light guide structure of the invention.

FIG. 5 is a top view of a multi-point constituent irregular surface type key cap of the invention.

FIG. 6 is a top view of a three-point constituent regular surface type key cap of the invention.

Notes of reference numerals in the figures: 1. backlight module; 11. luminescent lamp source; 111. luminescent components; 12. reflecting plate; 13. light guide plate; 131. reflecting surface; 132. light outlet surface; 14. light shading plate; 15. preset key cap; 2. light guide area; 21. light guide structure; and 3. mesh point.

### DESCRIPTION OF THE INVENTION

The invention will be further described in conjunction with the accompanying figures and specific Embodiments so that those skilled in the art can better understand the invention and implement it, but the embodiments given are not intended to limit the scope of the invention.

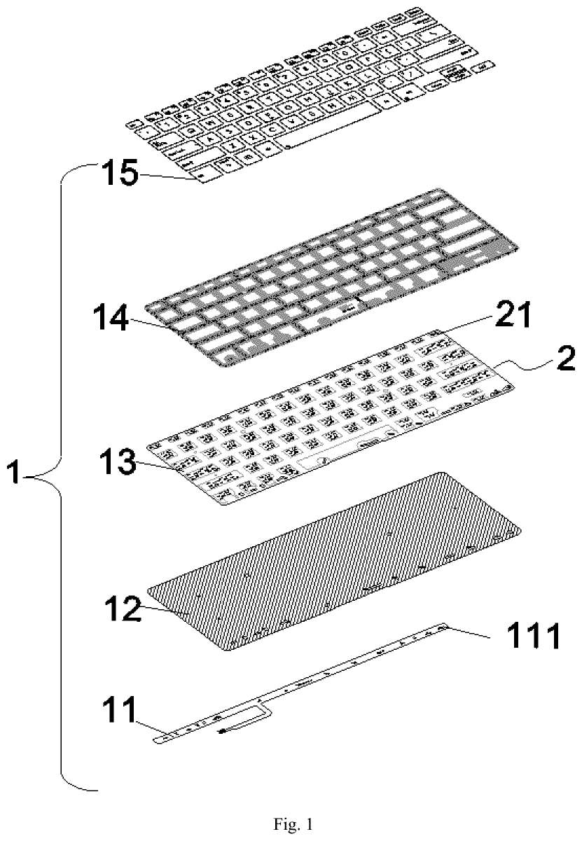

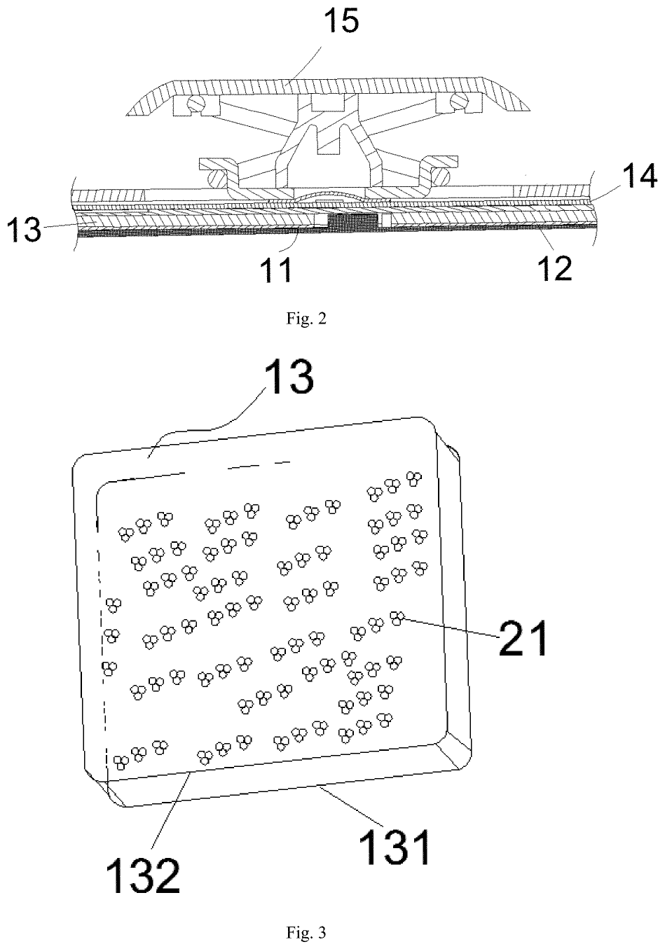

As shown in FIG. 1 to FIG. 6, a light-guide planar structure of a backlight module 1 according to an Embodiment includes a backlight module 1 including a luminescent lamp source 11, a reflecting plate 12, a light guide plate 13 and a light shading plate 14 with a plurality of preset key caps 15 thereon, which are sequentially arranged, and a light guide structure 21 which is arranged on the surface of the light guide plate 13, is planar and is a surface consisting of three or more circular or rectangular or regularly-shaped or irregularly-shaped mesh points 3; and the light guide structure 21 can be a standard geometric structure or an irregular geometric structure.

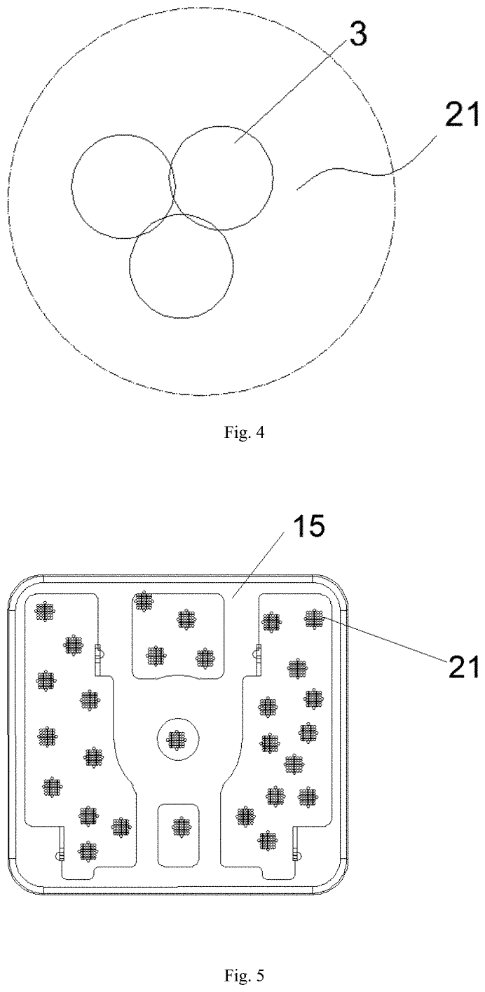

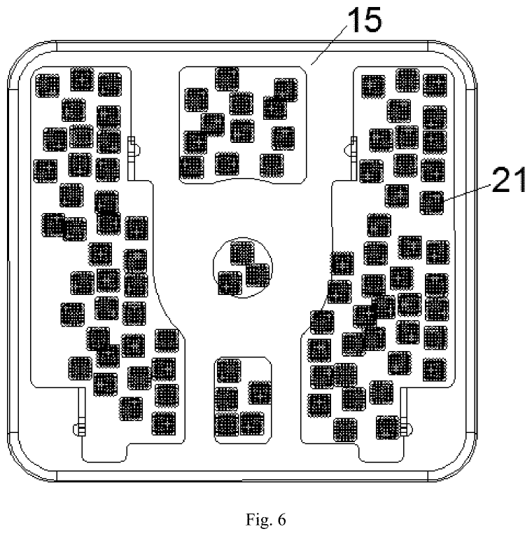

In use, when the parts are assembled and fitted on the surface of the light guide plate 13 of the backlight module 1, multiple light guide areas 2 are separately formed on the surface of the light guide plate 13 through a thermal transfer method, and are separately located below each preset key cap 15 above a light filter plate 14; multiple light guide areas 2 with predetermined shapes are formed on the backlight module 1; and the planar light guide structure 21 of the backlight module is formed by a three-point constituent type surface light guide structure 21 (as shown in FIG. 4), a multi-point constituent type irregular-surface light guide structure 21 (as shown in FIG. 5) or a multi-point constituent type regular standard geometric surface structure (as shown in FIG. 6).

The backlight module 1 of the invention can project the light source by the luminant lamp source 11 on the bottom for guiding the light source to the reflecting surface 131 of the light guide plate 13 and emit from the light outlet surface 132 after being reflected, so that the light source can be uniformly projected to any position around the bottom of each preset key cap 15, i.e., obvious bright-light effect around the bottom of each preset key cap 15 is kept, a light source loss phenomenon can be reduced, and excessive light sources can be saved, and thus, the number of the luminescent components 111 of the luminescent lamp source 11 on the backlight module 1 can be reduced. Moreover, the cost of the backlight module 1 is reduced, the light guide effect is uniform, the light guide quality is high, and light guide brightness is improved.

The reflecting plate 12 is made of the single-layer insulating material, and multiple luminescent components 111 are arranged on the luminescent lamp source 11, so that the luminescent effect is good.

The light guide structure 21 is arranged on the surface of the light guide plate 13 through the thermal transfer method, and the processing principle is as follows: the pre-planed light guide areas 2 (consisting of several mesh points 3) are processed on a steel sheet mold which is heated and is in contact with the light guide plate 13 for thermal transfer printing and processing; the heated steel sheet mold thermally transfer-prints the processed mesh points 3 thereof onto the surface of the light guide plate 13 of the backlight module 1; if the mesh points 3 are in regular shapes such as a circle, the diameters of the mesh points 3 are 0.01 mm-0.3 mm, the adjacent mesh points 3 are crossed, and the distance between centers of the circles is not greater than the diameter of single mesh point 3; if the mesh points 3 are rectangular, the center distance is not greater than the length or the width of single mesh point, so that the light guide plate 13 does not have an uneven phenomenon even the light guide areas 2 have a shallow printing phenomenon in a transfer-printing process; moreover, the light guide areas 2 can be guaranteed to have good light gathering and centralizing effect, so that the light guide effect is well, and the light source projected by the luminescent lamp source 11 is separately projected around the bottom of each preset key cap 15 through the multiple light guide areas 2; through different planar designs (the planar light guide structure 21 being a standard geometric structure or a structure with an irregular shape) of the permeable light guide areas 2, multiple light sources of the luminant lamp source 11 are attracted and centralized to any position around the bottom of each preset key cap 15, providing differential effect of luminescent brightness of different areas.

These Embodiments are only preferred Embodiments to illustrate the invention, and the scope of the invention is not limited thereto. Any equivalent alternative or modification made by the skilled in the art should be included in the scope of the invention. Therefore, the protection scope of the invention shall be the protection scope of the claims.

1. A light-guide planar structure of a backlight module, comprising a backlight module including a luminescent lamp source, a reflecting plate, a light guide plate and a light shading plate with a plurality of preset key caps thereon, which are sequentially arranged, and a light guide structure which is arranged on the surface of the light guide plate, is planar and is a surface consisting of three or more circular or rectangular mesh points.

2. The light-guide planar structure of the backlight module according to claim 1, wherein the light guide structure is formed by superposing and engaging a plurality of mesh points which are crossed with one another, and the distance of centers of circles of every two mesh points is not greater than the diameter of single mesh point.

3. The light-guide planar structure of the backlight module according to claim 1, wherein the light guide structure is arranged below the preset key caps.

4. The light-guide planar structure of the backlight module according to claim 1, wherein the reflecting plate is made of a single-layer insulating material.

5. The light-guide planar structure of the backlight module according to claim 1, wherein a plurality of luminescent components are arranged on the luminescent lamp source.

6. The light-guide planar structure of the backlight module according to claim 1, wherein the light guide structure is arranged on the surface of the light guide plate through a thermal transfer method.

7. The light-guide planar structure of the backlight module according to claim 1, wherein the light guide plate comprises a reflecting surface close to the reflecting plate and a light-emitting surface close to the light shading plate.
